(19) United States
(12) Patent Application Publication
(10) Pub. No.: US 2014/0042744 A1
(43) Pub. Date: Feb. 13, 2014

(54) ACCURATE BOUYANCY CONTROL IN POOLS,LAKES AND OCEAN AND MAINTAIN FREQUENCY GENERATING ELECTRICAL POWER

(71) Applicant: ARVIND A. DAYA, Fayetteville, GA (US)

(72) Inventor: ARVIND A. DAYA, Fayetteville, GA (US)

(21) Appl. No.: 13/659,406

(22) Filed: Oct. 24, 2012

Related U.S. Application Data
(63) Continuation-in-part of application No. 13/573,009, filed on Aug. 13, 2012.

(51) Int. Cl. E02D 25/00; F16D 41/00

(52) U.S. Cl. CPC E02D 25/00; F16D 41/00
USPC 290/42; 405/205; 192/41 R

(57) ABSTRACT

Buoyancy force can provide a large lifting force with little energy, but it requires a control system. In the present invention position control system is designed and implemented to keep the body with the load at a reference position or to control speed of ascent of the load, in the present invention the designed combination of buoyancy with ascent tuning control parameters operated repeatedly whereby to generate AC electrical power with aid of buoyancy in pool, lake and ocean continuously, the present invention is a buoyancy and gravity control mechanism which comprised of rigid unit to a fix size or collapsible accordion vinyl skirt bellow capsule chamber, therefore several methods that can be developed to take advantage to overcome the enormous torque at the gearbox to turn the generator to generate AC current for rural villages large business and supply the grid 24/7 continuously.

This application is a Continuation-In-Part of my patent application U.S. patent application Ser. No. 13/573,009 filled 13 Aug. 2012 and the contents therein contained are incorporated herein.

### FIELD OF INVENTION

The present invention relates to a more precise control of buoyancy, but not exclusively, for attachment to large structures being lower, lifted, positioned and transported on the ocean. The present invention relates to controlling the depth and motion of buoyancy force underwater. The invention generally applies to offshore floating structures used in the exploration and production of offshore minerals, such as semi-submersible vessels, tension leg platform and spur type platforms, more particularly to offshore floating structures having vertically spaced buoyancy capsule enclosed within an open cross-braced jacket framework or truss support structure including large floating offshore windmills This invention further relates more specifically in generating clean alternating electrical current with the aid of buoyancy in pools, lakes and ocean, with precise buoyancy control and gravity to regulate accurate frequency required to generate Alternating Current electrical power continuously.

### BACKGROUND OF THE INVENTION

Firstly there are many way of lifting and transporting a heavy structures in the ocean with certain amount buoyancy control, of these are pressurized air or gas inflated balloons and barges but non with a more precise control and rapid response in slowing down the lifting as the structure comes to the surface or maintaining a level float in the ocean surface.

Secondly there are many way to generate electricity today, among these are nuclear power, coal power, and gas power. However none of them is clean or reusable energy, these non-reusable fossil fuel resources such as liquefied natural gas, coal nor oil which will inevitably run out. Furthermore the fossil fuels environmental impact is causing serious cultural, socio-economic and climate crisis around the globe, not to mention the safety and costs of the nuclear power. Therefore, many domains that use fossil fuel are gradually adding reusable energy to curve the environmental impact such as solar energy and wind power. However, with limitations and restrictions such as topography, climate and geographical locations, causes inconsistencies in power generation, additionally wind power and solar power has high construction, upkeep and power transport (power lines) costs. The present invention can replace fossil fuel economy to sustainable renewable energy base economy and bring energy globally, furthermore this device operates 24/7 continuously.

Thus to overcome the abovementioned problems of prior art, the present invention has provided practicability after deliberate design, calculations evaluation and experience, developed and design to combine the related art.

### BRIEF SUMMARY OF THE INVENTION

It is a primary object of the present invention mainly provides repeated buoyancy control and generating Alternating Electrical Current continuously maintaining required frequency to the generator constantly.

An underwater lifting operation is common task, e.g. the offshore oil and gas production and the off shore wind industry. The current difficulties faced of lifting heavy structures off the ocean floor, these methods of adjustment of buoyancy by controlling the amount of air or gas in balloons and in its size, along with the safety of the diving team going in deep water for short period of time repeatedly to achieve the objective. Buoyancy can provide a large lifting force with little energy, but it requires a control system. In the present invention position control system is designed and implemented to keep the body with the load at a reference position or to control speed of ascent. In the said invention the designed combination of buoyancy with ascent tuning control parameters repeatedly whereby to generate AC electrical power with aid of buoyancy in pool or lake continuously.

First aspect of the present invention is buoyancy force control mechanism which is comprised of a rigid chamber of a fix size that is circular, square, triangular, rectangular or polygonal shape, to the desired length with one end of this chamber is open and the top end is a closed dome or cone shape to reduce friction during ascent of the chamber during buoyancy force. The said buoyancy chamber have a sealed piston with a sealed plunger rod or shaft fitted with “O” seal rings, the said plunger rod is piercing out through the top of the dome, a vinyl diaphragm can be fitted instead of the piston, the diaphragm installed in the chamber is attached to the inner perimeter at the open end of the chamber, the said diaphragm is attached to the plunger rod, the plunger rod is extended out through the top of dome or cone shape of the chamber to operate the sealed vinyl diaphragm. The piston type plunger buoyancy chamber as shown in FIG. 1 can be fixed as, plurality of bundle chambers that are attached in a row to a heavy structure to be lifted from the bottom of the sea or ocean floor, the said sealed rods or shafts and pistons are pushed to the bottom in each chamber, towards the open end of each said buoyancy chamber by the rod or shaft whereby displacing water in the chambers and creating a vacuum in the chambers, this vacuum is vented by installing a small vent pipe on the top of the dome or cone shape of each chamber which lead to the surface of the pool or lake except in deep ocean floor, the vacuum can be overcome by pressurized air or gas buoyancy chamber, thus creating buoyancy force to lift the heavy structure. As the structure is pulled up by buoyancy force to the surface, the said rod or shaft and piston or vinyl diaphragm in the chamber is drawn in gradually thus allowing water in the chambers thereby reducing the buoyancy force as the load comes to the surface whereby maintaining a steady lift. The process of pushing or pulling the plurality of said pistons by the shafts or rods in the chambers can be achieved in many ways (e.g. air pressure, hydraulics, mechanical screw, cables and leverage). In a pool or lake application air or hydraulic cylinder is attached to the shafts or rods of the said chambers. The hydraulic or air systems is operated from the surface and controlled by sensors and computers. As for the ocean floor application of pushing or pulling the plurality of the shaft or rods and pistons in the said chambers modules along with additional linked chamber modules aligned in row. The pushing and pulling is achieved by cables attached from a electric or hydraulic winch to a shaft or rods on top dome or cone shape side of the first sets of chambers on the structure and interconnected each other up to the bottom of the last sets of chambers in that row, the said rods of the chambers is extended equally through the piston at the bottom of the last sets of chambers, the extended rods are attached in a similar manner to a second electric or hydraulic winch towards the bottom of the structure, thus both end of electric or hydraulic winches operate independently to locate the pistons to the appropriate location in the chambers to increase or to decrease buoyancy force as needed to control the structure as the structure comes to the surface. Additionally vacuum created by the sealed pistons in the chambers, these unbalance forces in and outside the chamber can be defused as depth increases by a compressed air or gas. The said buoyancy force control system can be operated from the ocean surface electrically with electric winches, or hydraulic controlled winches. A rigid circular buoyancy chamber or large diameter tube may be used to achieve the goal.

According to the second aspect of the present invention is for larger structures to be lifted off the ocean in depth of approximately 6 meters to 144 meter against pressures up to 14 bars. The design of the buoyancy device is a collapsible chamber, the collapsible chamber is a folding bellows skit whereby the structure of the collapsible bellow chamber skeleton frame is rigid to withstand pressures well above mentioned pressures yet it is collapsible with aid of hydraulic or air cylinders operated from above water surface. The collapsible accordion skirting bellow chamber follows the movement of the expansion to ensure protection through the complete cycle of the expending and collapsing operation and to maintain the displaced water space thereby required buoyancy force. The buoyancy chambers of small size generator or a large Mw Generating capacity power plant of this device uses circular, square, triangular, rectangular or polygonal shape collapsible bellow chambers and can be inserted with a scissor expendable type of a mechanism to expend the collapsible bellow chambers from inside the collapsible skirting of the said bellow chamber, with aid of hydraulics, air and or cables. The scissors expending skirt bellows follow the movement of the chamber to ensure protection and buoyancy through the complete cycle of the expending and collapsing operation.

In generating electricity with aid of gravity and buoyancy as illustrated in FIG. 3, the buoyancy and gravity plays a major role thereby buoyancy control is applied to one end of long rigid lever arm along with variable gravity load to the other end of the long lever arm for homes and smaller businesses. Buoyancy force is lifting one end of the said arm at the same time gravity load is applied at the other end of the arm thus turning the gearbox shaft at midpoint of the long lever arm. These forces on both sides of the long lever arm plays a vital role simultaneously to achieve the desired rotation with the aid of a one way clutch mechanism to turn the gearbox shaft of enormous torque, this is accomplished by adding multiple arms of identical design on the said common gearbox shaft to overcome that enormous torque to maintain the desired rpm on the generator for AC frequency. These arms are controlled and regulated to maintain the desired rpm at the generator end, this is accomplished with an aid of a hydraulic system that is further controlled by microprocessors. In generating electricity on a power plant scale with aid of buoyancy as illustrated in FIG. 6 and FIG. 14, the buoyancy force plays a major role.

In generating electricity with aid of gravity and buoyancy as explained in above paragraph, the buoyancy plays a major role on larger unit. The present invention can be implemented globally to generate clean electricity on huge scale to large industries and homes and supply the grid, furthermore in rural villages with no access to electricity where one unit of a medium size can power all the surrounding villages and farmers for agriculture, furthermore globally we can start replacing the nuclear and the fossil fuel power plant with the larger units of the present invention, the buoyancy and gravitational forces to produce clean and safe electrical power continuously.

### BRIEF DESCRIPTION OF THE DRAWINGS

The invention is better understood by reading the following Detailed Description of the Preferred Embodiments with reference to the accompanying drawing figures.

FIG. 1 depicts of a fix size rigid buoyancy module and a section through buoyancy chamber

FIG. 2 depicts of a sections detail of the collapsible buoyancy chamber in operation for smaller generator sets along with scissor jack (lift) type of a mechanism.

FIG. 3 a depicts an overall view of the electrical generator mechanism with aid of pool buoyancy force.

FIG. 4 a depicts section view of the generator mechanism with aid of pool buoyancy force and weight.

FIG. 5 depicts a view of sprocket and chain assembly on long lever arm in an electrical generator mechanism with aid of pool buoyancy force and gravitational weight.

FIG. 6 depicts a view of large Mw capacity AC electrical buoyancy force generator on concrete platform with support pillars.

FIG. 7 depicts a front view of the large AC electrical buoyancy generator arms swinging action.

FIG. 8 depicts a section view of the elongated open cross-braced jacket truss framework interconnected rigid massive formed of tubular torque arm and buoyancy chamber floating position.

FIGS. 9a and 9b depicts an expanded gas or air expended space in buoyancy chamber and expanded water space in a buoyancy chamber in operation along with scissor jack (lift) type of a mechanism.

FIG. 10 depicts a multiple large rectangular or square vinyl skit accordion collapsible bellow folding chambers along with a scissor lift expendable type of a mechanism that is inserted into the folding capsule chamber on a single elongated open cross-braced jacket frames formed of tubular member arm.

FIG. 11 depicts a one way clutch assembly (overrunning clutch assembly) for larger Mw size electrical generator units.

FIG. 12 depicts a hydraulic disc brake and rotor type as a one way clutch assembly for smaller generator sizes.

FIG. 13 depicts a mechanical jaw brake and rotor type with a jaw calipers as a one way clutch mechanism for larger generator units

FIG. 14 depicts a Mechanical buoyancy electrical energy generator.

FIG. 15 depicts related parts and function of the mechanical buoyancy chamber

FIG. 16 depicts a sprocket chain attached to the single buoyancy chamber with scissor jack.

### DETAILED DESCRIPTION OF THE PREFERRED EMBODIMENTS

Buoyancy can provide a large lifting force with little energy, but it requires a control system. In the present invention buoyancy position control system is designed and implemented to keep the body with the load at a reference position or to control speed of ascent of the load in a pool or ocean. In the said invention the designed combination of buoyancy force with ascent tuning control parameters operated repeatedly whereby to generate alternating electrical current with aid of buoyancy forces in pool, lake and ocean continuously, furthermore in areas where temperature harbors below freezing antifreeze can be added to the pool to keep the buoyancy chambers to operate continuously despite freezing conditions. The present invention is a buoyancy control mechanism which comprised of rigid chamber, of a fix size or collapsible accordion vinyl skirt bellow capsule chamber, to the desired length, width or height, furthermore the said buoyancy capsule chamber may be made of stainless steel, aluminum, titanium, fiber, vinyl reinforced material or other suitable materials with watertight integrity suitable for marine applications under high pressures.

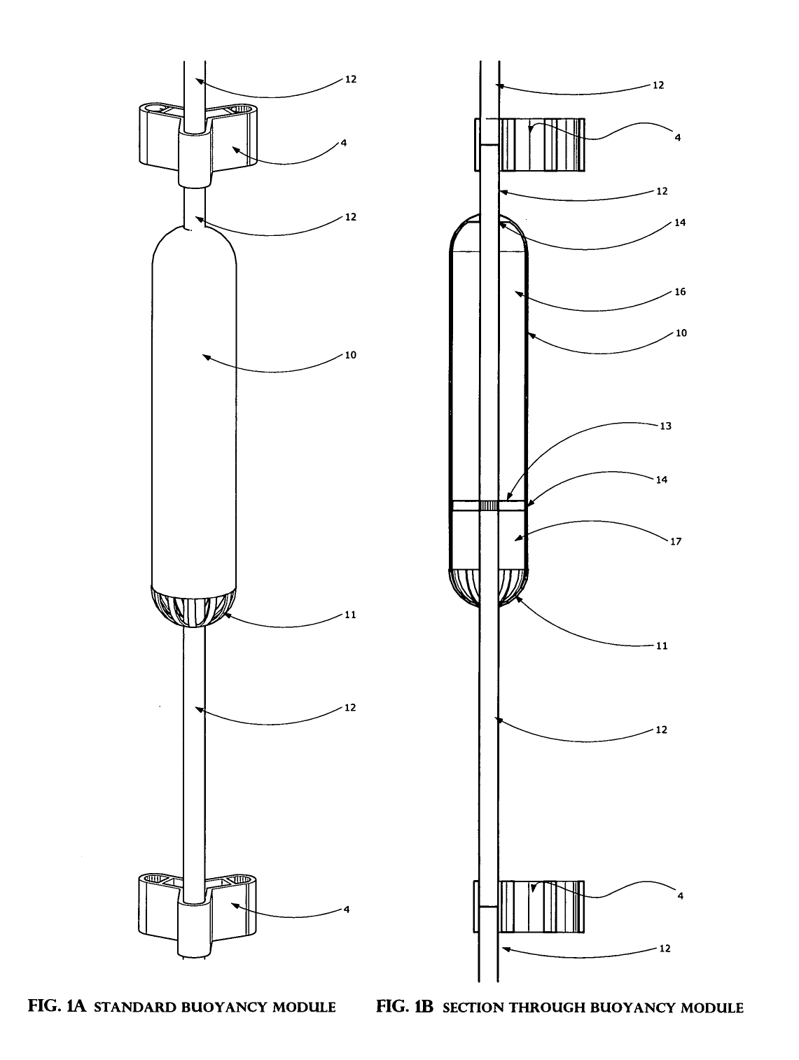

Referring to FIGS. 1a and 1b in a rigid buoyancy capsule chamber of a fix size that are circular, square, triangular, rectangular or polygonal shape to the desired length, with the bottom ends of this capsule chamber is open and the top end is a closed dome or cone shape to reduce friction during ascent of the chamber during buoyancy. Each of these chambers will have a sealed piston 13 with a sealed plunger rod or shaft 12 fitted with “O” seal rings 14. Buoyancy force in present invention with aid of a cylinder 10 is designed so that its cylinders can withstand as much external water pressure as possible. Stronger the cylinder 10 walls, the higher pressures it can withstand and deeper towards the ocean floor the load can be lifted in controlled manner. The top of the cylinder 10 is dome/cone shaped to reduce friction upon ascent of the structure if attached upright, should the cylinder 10 be placed horizontal on the said structure would have no adverse effect on friction. The piston 13 is fitted with “O” seal rings 14 including the shaft/plunger 12 rod at dome area to prevent water from entering the cylinder 10 chamber, as the shaft/plunger rod 12 moves back and forth moving the sealed piston 13 in the cylinder 10 thus increasing or decreasing the buoyancy force as desired. The bottom of the said cylinder 10 is open with a strainer cap 11 causing the water to freely displace from the bottom of the cylinder 10. The diameter of the cylinder 10 will vary as desired per design.

Much longer cylinder 10 can be operated on the ocean floor attached to a large structure without the use of shaft/plunger 12 attached to the piston 13. Longer cylinders have a longer piston 13 so they may not kink while sliding without the shaft/rod 12 in the cylinder chamber, along with a sealed steel cable passing through the centre of the said longer piston 13, the steel cable is further clamped to the piston so as to move the sealed piston 13 in both direction in the said cylinder without the cable sliding through the piston 13, the top dome/cone area will be sealed only allowing the cable passing without allowing water entering the cylinder. Additional cylinders 10 can be bundled and operated in similar manner with the aid of cable guides, operated with hydraulic or electric motor winch as described above.

A major advantage of the said invention is the buoyancy volume of the displaced water in the said chamber is close to precisely maintained to the specified volume thereby the entire journey of the payload from the sea floor to the surface, the speed of ascent of the payload is maintained, compared to the underwater air filled lifting bags, where despite their usefulness are not safe. Specifically, they have one major drawback; the acceleration can create enormous unpredictability in the ascent of a payload as the lift bag reaches the extremely high vertical velocities upon reaching the surface.

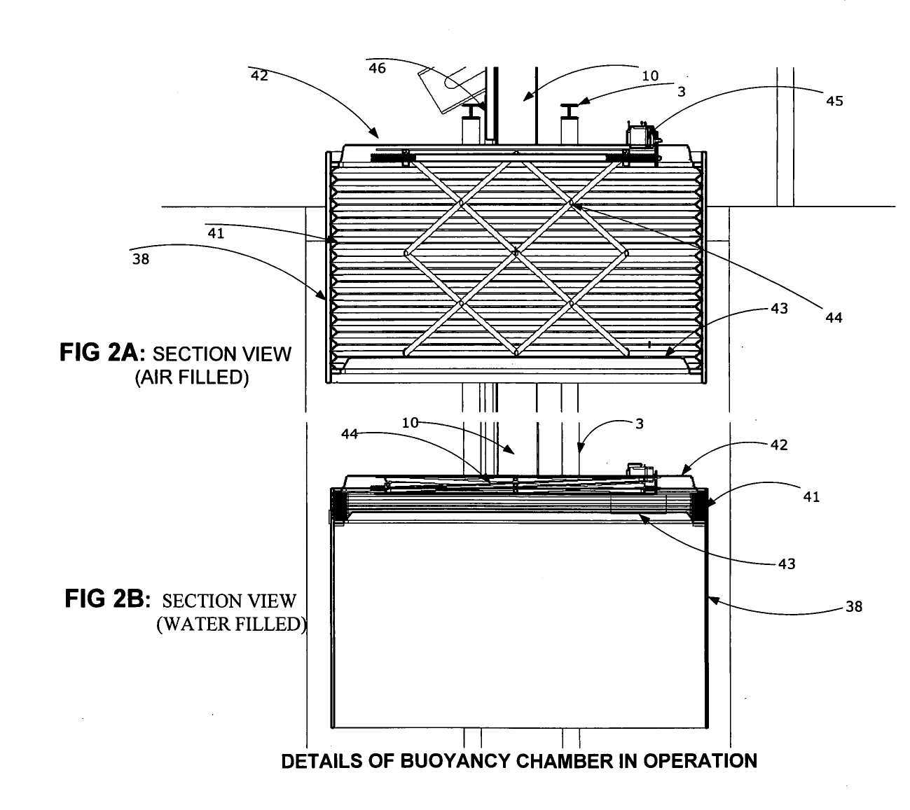

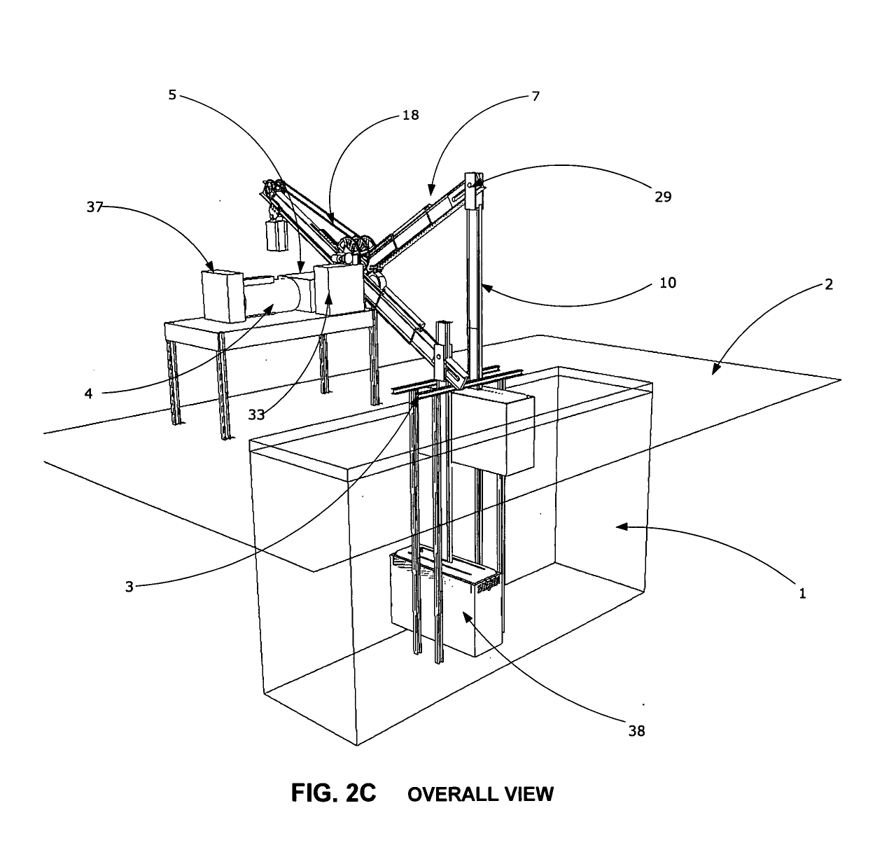

Referring to FIGS. 2a and 2b in the collapsible accordion folding skirt bellow 41 capsule chamber with vinyl, rubber or other suitable materials with watertight integrity suitable for marine applications. Buoyancy chamber 38 and the top rigid cap 42 are fixed to each other as a box form and the said expandable vinyl 41 collapsible capsule folding chamber is fixed to rigid with a large metal disc 43 suspended depending on the shape of the buoyancy chamber that is sealed and shut thus creating a vacuum when expended and pressure when collapsed, this pressure or vacuum is overcome by a pressurized buoyancy chamber or is vented above the water surface with atmospheric pressure or compressed gas in an accumulator at the surface not shown, this method of venting applied to all the different structural designed buoyancy chamber explained in the present invention. The structure of a collapsible bellow chamber frame 38 is rigid metal to withstand pressures well above 4.45 bars, the vinyl collapsible folding chamber with aid of hydraulic, air cylinders or a ball screw shaft driven by air motor, gas motor or electric motor 45 operated from above water surface. Top end of the said buoyancy capsule chamber 42 has a column 10 piercing out the said buoyancy capsule chamber frame 38 that is reciprocating the long arm in FIG. 3 (#7). The collapsible accordion skirt bellow folding chamber 41 follows the fold movement of the expansion to ensure protection through the rigid buoyancy chamber 38 as complete cycles of the expending and collapsing operation and to maintain the displaced water space thereby the required buoyancy force. The vinyl collapsible bellow buoyancy chambers can be circular, square, triangular, rectangular and polygonal in shapes, furthermore the said buoyancy chamber can be operated with an air or hydraulic cylinder or ball screw 45 scissor jack (lift) 44 type mechanism with electric motor or air motor.

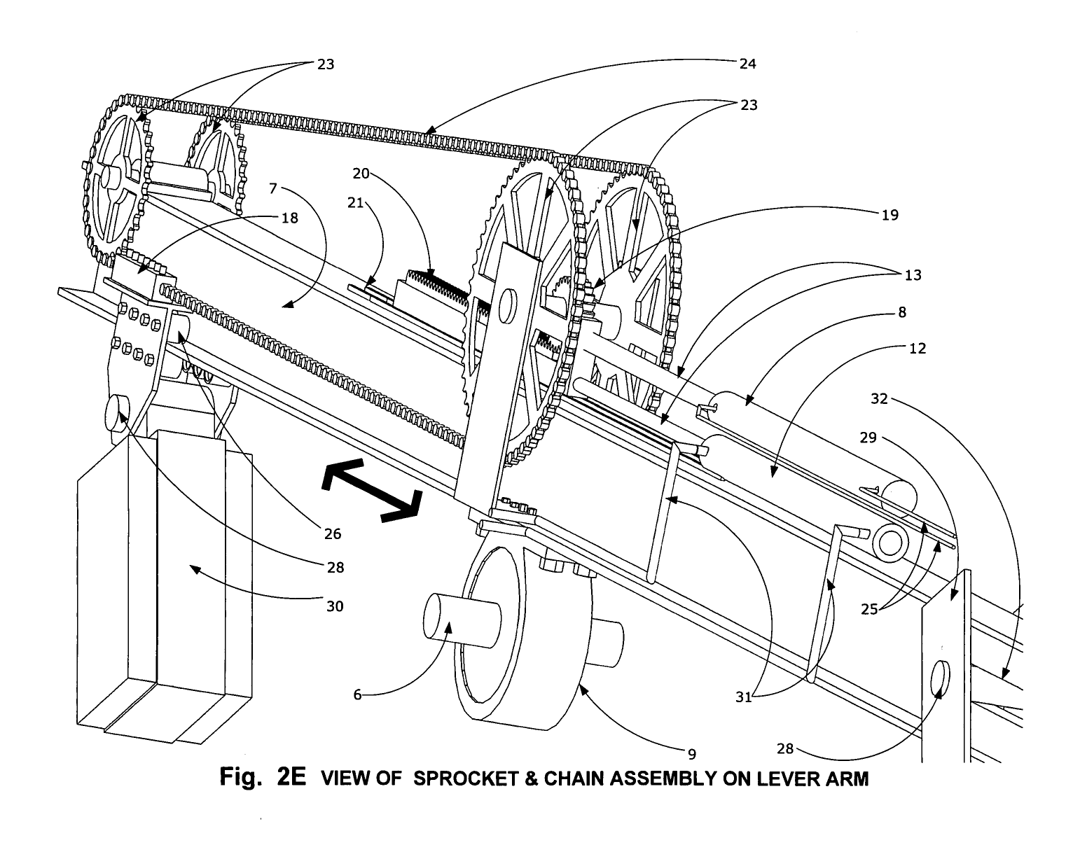

Referring to FIGS. 2, 3, 4 and 5 details of mid size buoyancy electrical generator where buoyancy force and moving of weights 30 thereby gravitational force, this reciprocating of long lever arm 7 at midpoint of the said arm, the up and down movement of the vertical column 10 during the upward force of the buoyancy chamber 38 at the vertical column 10 simultaneously downward force of the weights 30, thus positive force is exerted to the gearbox 5 whereby the smaller 4 generator of 20 Kw and up. Once the long lever arm 7 reaches the bottom of the angle of operation on weight side, both hydraulic cylinders shafts 13 operate as a unit is retracted thus causing the gear rack 20 to retract on roller bearing rail 20 to turn the involute gear 19 whereby to turn large sprocket gears 23 as a unit to turn clockwise, causing the sprocket chain 24 riding on outer sprockets 23. The chain is fixed 18 to move the weights 30 on bearings 26 toward the center of the long lever arm 7. The slave cylinder 8 is driven by primary master hydraulic cylinder 12 as both hydraulic shafts 13 moves, thus the slave cylinder 8 supply hydraulic fluids to the buoyancy hydraulic cylinder not shown located in the buoyancy chamber 38 in appropriate directions. The movement of the gravity force, weights 30 on one end of the long lever arms and the buoyancy force other end are controlled and regulated to maintain the desired rpm at the generator 4 end, this is accomplished with an aid of a hydraulic system and or air that is further controlled by microprocessors. An overall view of the collapsible accordion skirt bellows buoyancy chamber 38 forces and variable gravity weight force simultaneously apply rotational force to generate AC electricity in the present device with the aid of a one way clutch, thus additional units of the said long lever arm 7 assemblies is added to the gearbox 5 shaft as needed to overcome the enormous force to turn the gearbox whereby the generator. The buoyancy chambers can be operated with the aid of a pool. In the present invention smaller AC electrical generator, can equipped with two types of buoyancy capsule chambers, one is the rigid of a fixed size as in FIG. 1 or a collapsible accordion folding skirt bellow capsule chamber as in FIG. 2 with vinyl type buoyancy chamber 38. By adding identical long lever arms 7 of same specification to the gearbox shaft 5 as required to turn the gearbox shaft 6 to achieve a positive sinusoidal reciprocating motion of each arm causing the generator to maintain the frequency/rpm to produce AC electrical power continuously. This entire operation is controlled and regulated to maintain the desired rpm at the generator 4 end, this is accomplished with an aid of a hydraulic and or air system that is further controlled by microprocessors. In the present invention of a small electric generating device, the device would work just the same with or without the weight control mechanism except the buoyancy force would be increased and reciprocating arms will not be operated from the middle of the arm but the end of the long arm directly to the overrunning clutch with no weight control mechanism, thus by increasing the buoyancy force and achieving the similar results as the larger generators as explained in next paragraph with or without the concrete support structure.

The following are the reference number to each part in the set of drawing from FIGS. 2 to 5
1 Pool
2 Ground Level
3 Support Structure
4 Generator
5 Transmission (Gearbox)
6 Main Shaft
7 Main Lever Arm
8 Slave Cylinder
9 One Way Clutch (overrunning clutch)
10 Vertical Column
11 Rigid Frame
Hydraulic Cylinder
13 Hydraulic Piston Combined as a Unit
14 Plunger
15 Plunger seal
16 Buoyancy Cylinders
17 Sealed Disk
18 Sprocket and chain assembly that moves the weight along the lever arm.
19 Involute gear
20 Gear rack on roller bearings
21 Guides for gear rack
22 Sliding weight assembly
23 Sprocket gear
24 Roller chain
25 Slave cylinder hydraulic lines
26 Weight support bracket on roller bearings
27 Chain lock fixed to weight support bracket
28 Pivot with bearings
29 Bracket
30 Dead weight
31 Master hydraulic cylinder lines
32 Slotted pivot guide
33 Hydraulic tank
34 Hydraulic pump
35 Electric Motor
36 Computer controlled valves for hydraulic lines
37 Main Electrical Distribution Panel
38 Buoyancy Chamber
39 Section showing Buoyancy Chamber filled with Air as it ascends
40 Section showing Buoyancy Chamber filled with Water as it descends
41 Rubber or vinyl Bellows Seal attached to Top and Bottom plate
42 Top Steel Plate attached to Vertical Column (10), Scissor Jack Assembly and to the Bellows Seal
43 Bottom Plate attached to Scissor Jack Assembly and Bellows Seal
44 Scissors Jack Assembly
45 Electric Motor powering Scissors Jack
46 Vent Stack channels the flow of air to and from the Buoyancy Chamber

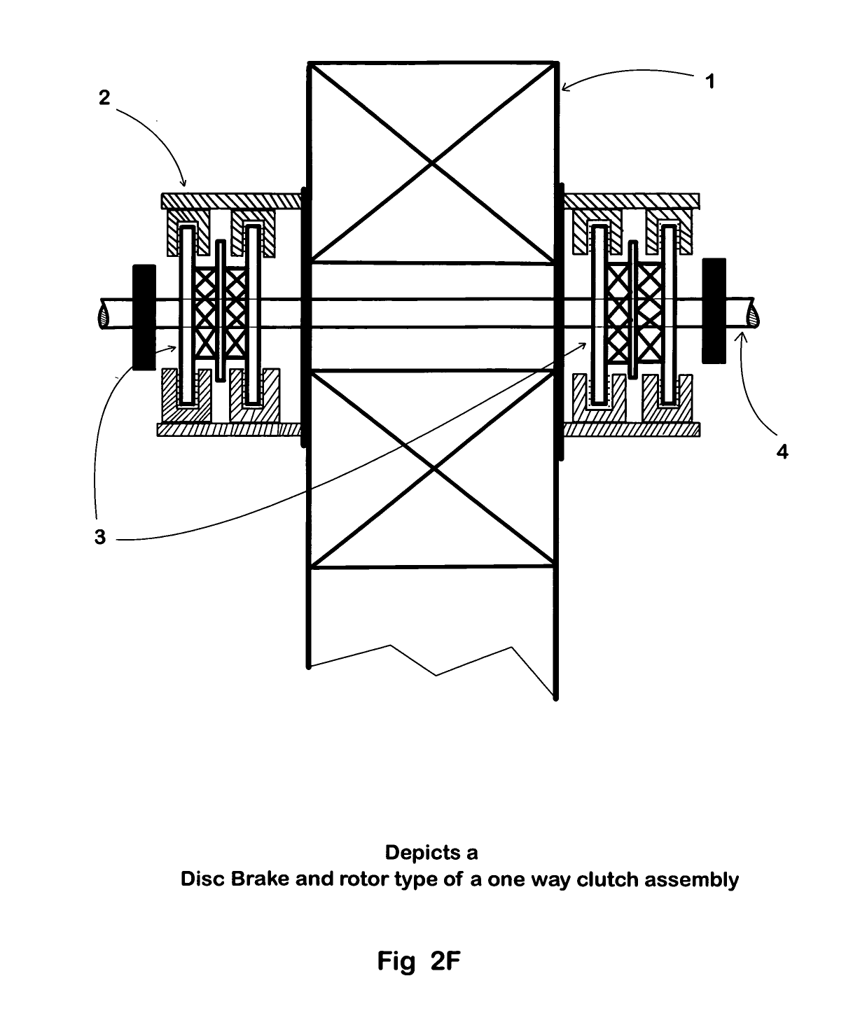

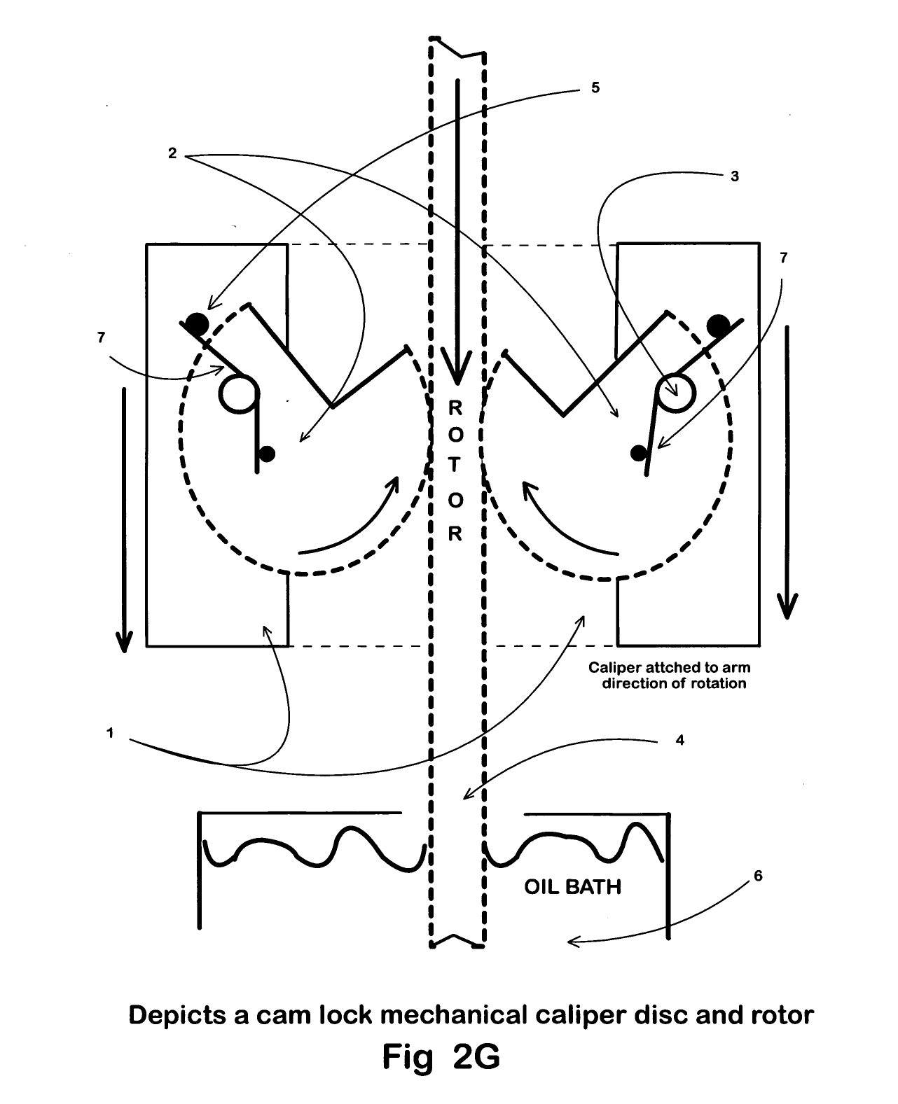

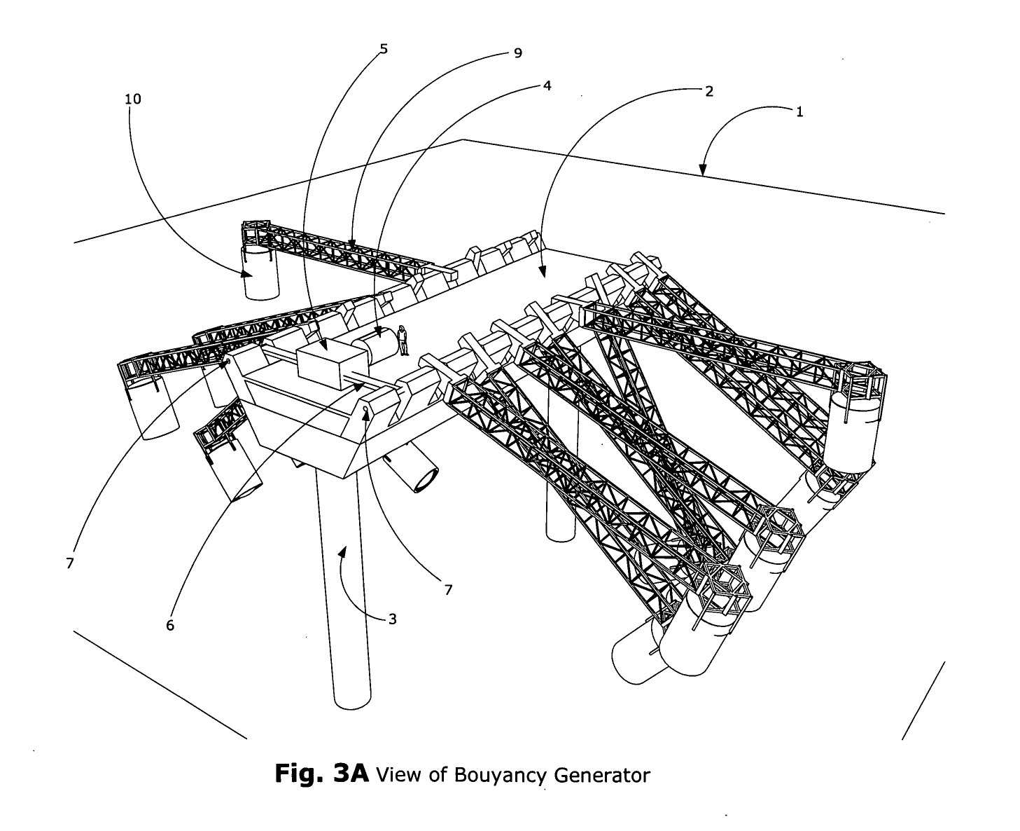

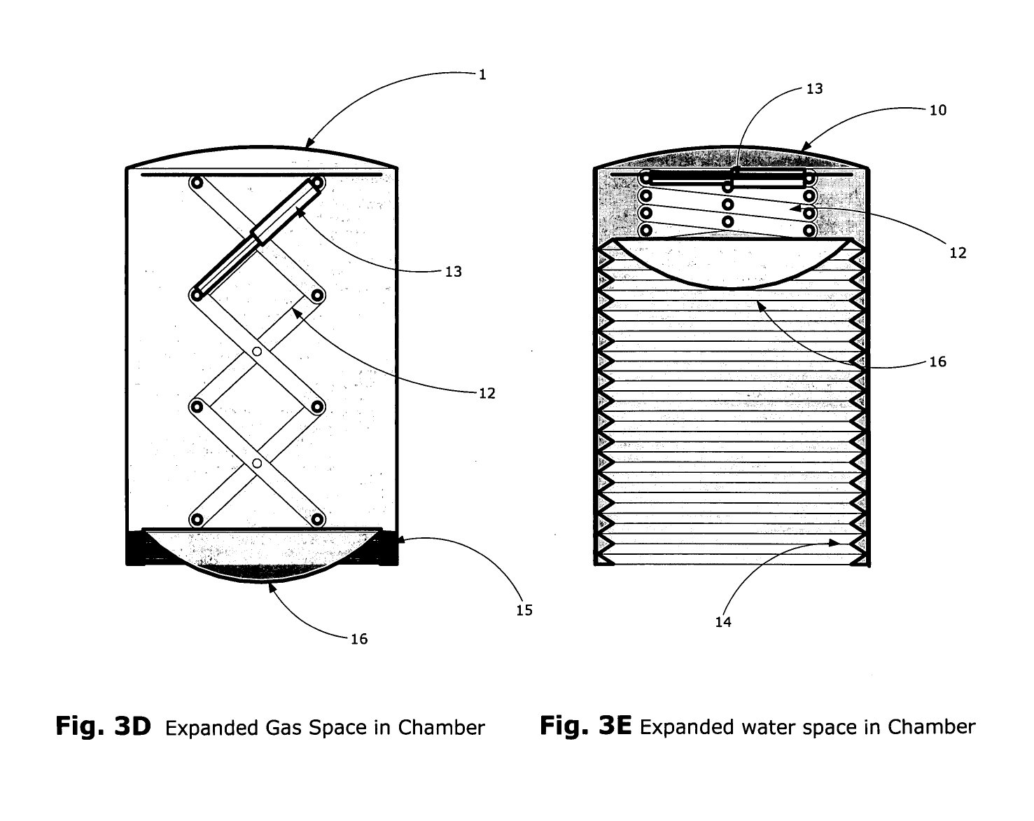

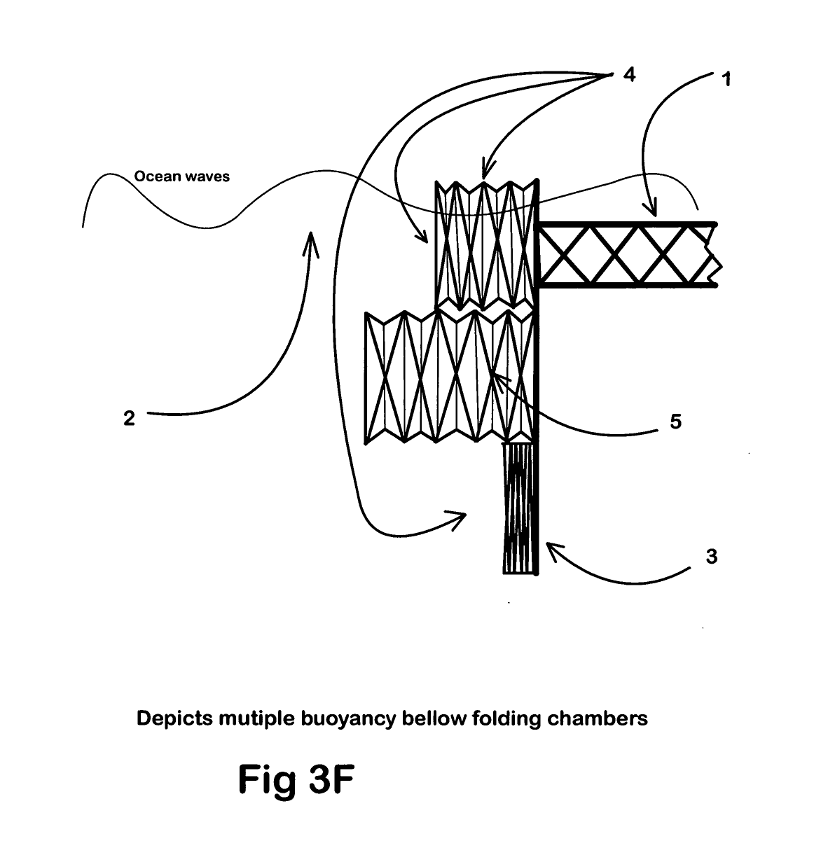

Referring to FIGS. 6, 7, 8 and 9 the present invention of buoyancy control is deployed to be used on larger Mw AC power plant size generator sets, a concrete structural elongated deck platform 2 on the ocean surface anchored to the shallow ocean floor with extended support pillars 3. Two shafts 7 connected to a gearbox 5 are laid out with support structures on the said concrete deck 2 platform almost the entire length of the said deck. An (EOCTFIRMFTM) elongated open cross-braced jacket truss framework interconnected rigid massive formed of tubular member 9 arms are each connected to the said gearbox shafts 7 alongside each other. One end of the entire EOCTFIRMFTM 9 arms are each connected to the said long gearbox shafts 7 at 90 degrees (perpendicular) as a elbow, along with a massive overrunning clutch assembly 8 as described in FIGS. 11 and 12 on the said gearbox shafts 7, furthermore the EOCTFIRMFTM arms are shown as four sided box-like configuration tubular arm 9, it should be understood that the said arms maybe triangular or have three or more sides. At certain sites or locations only one long gearbox shaft may be used on the concrete deck platform to connect perpendicular to the EOCTFIRMFTM arm 9 members on one side of a single shaft appropriately accommodated per design due to high sea current conditions not shown. The said EOCTFIRMFTM arms 9 as reciprocating long arms, having first and second end to each elongated tubular arm member, the first end is connected to any of a large one way clutch 8 assembly as explained in FIG. 11, 12 or 13 mechanism which is inserted in the long shaft 7 as to turn a positive rotation on the gearbox 5 shaft. The pair of said long gearbox shaft 7 parallelly located on the concrete platform whereby each shaft have its own sets of said EOCTFIRMFTM arm 9 attached back to back at the first end of EOCTFIRMFTM arm is connected to the two gearbox shafts 7 side by side thereby to drive the gearbox 5 accumulatively. The said second end of the each and every EOCTFIRMFTM is fixed to the large triangular, rectangular, square, polygonal or circular as in this case vinyl collapsible bellow folding buoyancy 10 chamber inserted with a scissors lift 12 type assisted expending mechanism, operated by a hydraulic cylinders 13 or ball screw mechanism with electric motor or air motor from the water surface. During the expansion and contraction of the collapsible accordion skirt folding vinyl collapsible bellow folding buoyancy 10 chamber inserted with a scissors lift (jack) 12 type assisted expending mechanism, vacuum or pressure is exerted in the said buoyancy chamber, this is overcome by venting or by an accumulator assisted gas from above the water surface, Furthermore air motors can be used to operate the scissor jack type of a mechanism in the buoyancy chamber, the same said air used for the air motor can be used to inflate or offset the external pressures to a certain extend in the buoyancy chamber. As for larger AC electrical generator the bellow buoyancy 10 chamber's force is the major player in applying force since the weight of EOCTFIRMFTM arm 9 has a substantial gravitational force to sink the said EOCTFIRMFTM arm towards the bottom. Upon the positive ascent by the buoyancy force of each of the said EOCTFIRMFTM arm 9 on second end of said arm, as understood by referencing the diagram in FIG. 8 whereby first end is attached to the long gearbox shaft on a concrete platform along with a massive one way clutches 8 as explained in FIG. 11 to FIG. 13 to overcome the enormous torque by the gearbox 5 to turn the generator 4 at the desired rpm. The structural elongated platform 2 on the ocean surface can be designed with two sets of gearbox and generator, one at each end, not shown. Additional EOCTFIRMFTM arm 9 members can be added to the long gearbox shaft 7 as needed or for spare units when some arm units in the gearbox shaft becomes defective thus continue to achieve the desired rpm on the gearbox shaft to maintain the required frequency of the generator or on an upgrade. A positive reciprocating movement of the EOCTFIRMFTM arms on both sides of the two long gearbox shafts is rotating in opposite direction to each other thus the accumulative force of the two gearbox shafts 7 transfers to a common gearbox shaft that enter the gearbox 5 input side thus the large Mw capacity generator are maintaining the required rpm to the set frequency to produce AC electrical power generator whereby to the step up transformers to supply the grid. The said sinusoidal reciprocating at the second end of EOCTFIRMFTM arms 9 are guided with a structure mounted to the seafloor and or protected with a slotted silo oval shaped type open cross-braced jacket frames formed around the said collapsible buoyancy chambers along with roller guides to protect from the sea current, as the buoyancy chambers continuously goes up and down along with the second end of the long rigid arms thus preventing the current from exerting sideways force to the collapsible buoyancy chambers as they travel up and down. At sea where ocean current will have a significant impact on the performance of the elongated open cross jacket frames rigid massive arms as they reciprocates, for that reason a row of interconnected slotted oval shape silo type large structure of jacket member frame mounted to the sea floor to encase the circular collapsible accordion skirt bellow folding buoyancy capsule chamber as to allow the sea current force to be reduced that impacts and to protect and guide EOCTFIRMFTM arm along with a platform on the said row of interconnected slotted oval shape silo type large structure of jacket member frame to accommodate an accumulator and all necessary accessory for each said EOCTFIRMFTM arm is not shown.

To overcome the enormous torque force of the gearbox 5 thereby the generator 4 and the gravitational force(weight) of the EOCTFIRMFTM arm 9 is achieved by vinyl collapsible bellow folding chamber 10 inserted with a scissors lift type assisted expending mechanism 12, the size of these collapsible bellow folding rigid chamber 10 can be significantly increased or by inserting multiple additional collapsible bellow folding rigid chambers 10 with expendable scissors lift type mechanisms side by side on each of the EOCTFIRMFTM arm 9 and operate as a unit, furthermore a major benefit of the said design all of the functioning apparatus in the buoyancy chamber is sealed from the ocean saltwater thus extending the service life of each said apparatus.

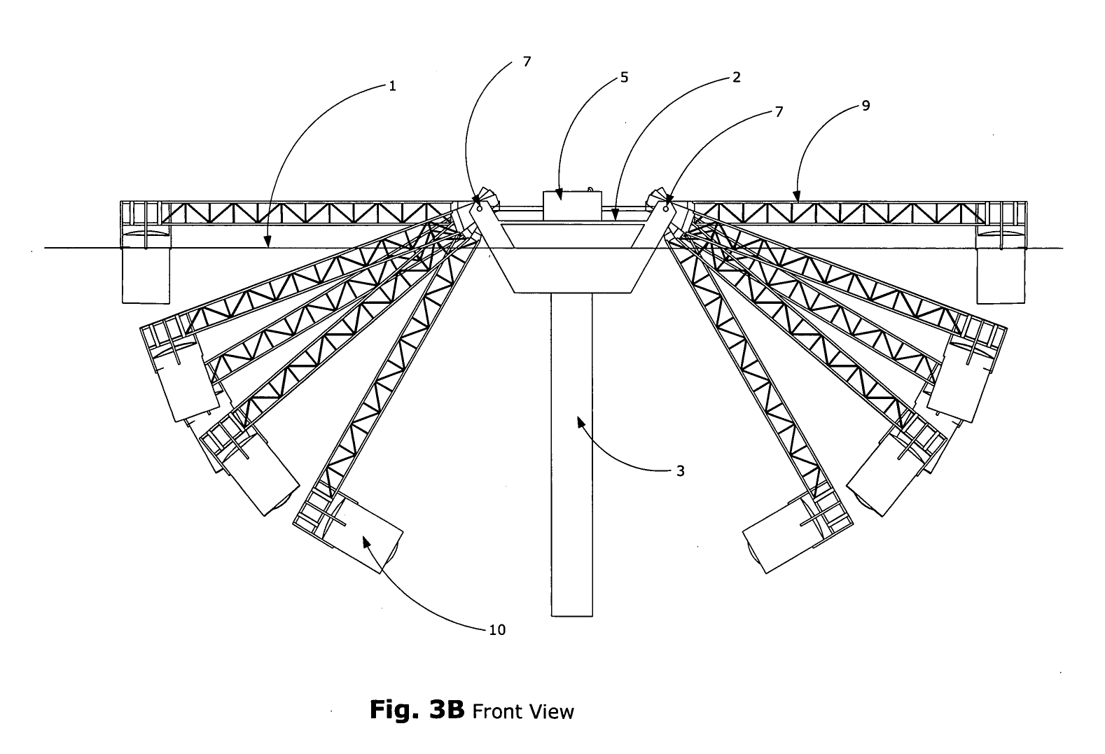

Referring to FIGS. 9a and 9b a buoyancy chamber of different shapes can be rectangular, square, polygonal and circular shapes of rigid chamber 10 with vinyl or rubber accordion collapsible bellow folding inner chamber 14 with aid of a hydraulic scissor jack (lift) mechanism 12, exerting pressure on the rigid disc 16 thereby displacing water and increase buoyancy, the collapsible inner chamber is a folding bellows. A scissors lift 12 type assisted expending mechanism is enclosed in the said collapsible buoyancy chamber 14 of vinyl or rubber skirt and bellows fold follows the movement on the chamber walls 10 to ensure and to overcome the external pressures on the said walls, that are protected thereby maintaining the specified buoyancy. The major advantage of this design is the collapsible bellow folding chamber 14 is protected when the scissor 12 jack (lift) type device is expended by the hydraulic cylinder 13 or a ball screw electric motor or air motor thus as the vinyl or rubber bellow fold collapse 14, the bottom disc 16 is sealed by a rubber seal 15 and protects the vinyl collapsible bellow fold thus maintaining the displaced volume of water, furthermore when the said scissor 12 lift contracts pulling the rigid disc 16 in the chamber thus the vinyl or rubber bellow unfolds allowing water to enter the chamber. This entire operation of the buoyancy chamber is controlled from the surface.

The following are the reference number to each part in the set of drawing from FIGS. 6 to 9
1 Water Body
2 Platforms
3 Platform Columns
4 Electric Generators
5 Transmissions
6 Drive Chains
7 Main Shafts
8 One Way Clutch at Pivot
9 Torque Arm
10 Chamber that alternatively fills with gas or water
11 Accumulator Cell that store and exchange gas with chamber
12 Scissor Jack
13 Hydraulic piston
14 Vinyl and or Rubber Concertina Gasket Expanded (separates the water from gas space)
15 Vinyl and or Rubber Concertina Gasket Contracted
16 Metal Disk moved by scissor jack

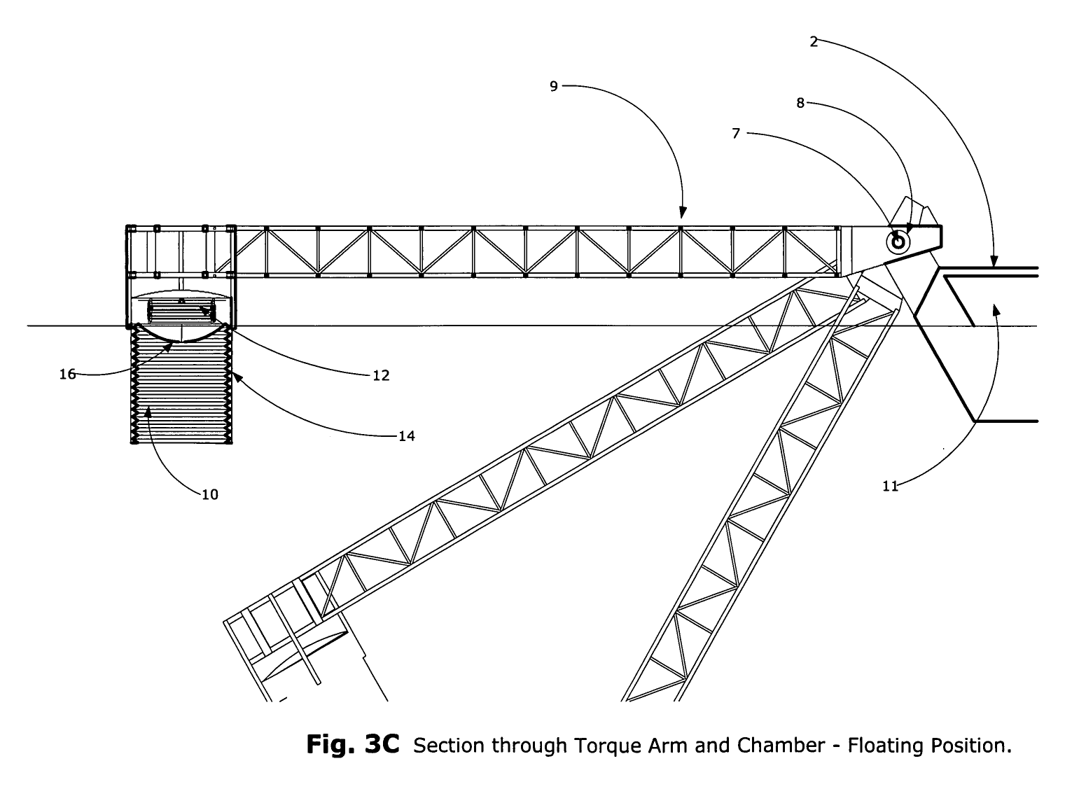

Referring to FIG. 10 the large multiple rectangular or square vinyl accordion collapsible bellow folding chambers. The collapsible chamber is a folding bellows skit 4 is attached to a rigid folding skeleton structure of collapsible bellow chamber frame that is rigid to withstand high pressures, furthermore a scissor lift 5 expendable type of a mechanism is inserted into the folding capsule chamber is to assist in expending the collapsible bellow folding chambers from inside the said collapsible skirt bellow chamber. The elongated open cross truss-braced truss tubular arm 1 as a reciprocating long arm as in this case is fixed to the three individual bellow folding chambers 4 to the support 3 fixed to the said elongated open cross truss-braced truss tubular arm thus each of the buoyancy chamber 4 can be controlled to expend or contract to maintain the desired force. The elongated open cross truss-braced truss tubular arm 1 that would be required to overcome the both the weight of the said elongated truss tubular arm 1, and all the buoyancy chambers 4 on the elongated open cross truss-braced truss tubular arm 1 and the resistant force of the gearbox shaft and the generator to maintain the specified rpm on the generator. With the aid of hydraulics, cables or ball screw shaft driven by air motor or electric motor all controlled from above the water surface. In the present invention the collapsible bellow skit fiber reinforced vinyl material is suitable material that is watertight integrity suitable for marine applications under high pressures, rugged UV resistant fabric, high strength, superior abrasion resistance and not affected by most petro-chemicals. The scissors assisted mechanism 5 expending vinyl skirt and bellows fold follows the movement of the chamber to ensure protection and buoyancy through the complete cycle of the expending and collapsing operation. Each vinyl fold section of the collapsible bellow folding chambers is reinforced with a heavy gauge chain link fence type of a wire link embedded in between the two layers of fiber reinforced vinyl skin of the said fold section along with maintaining a sealed chamber with a embedded wire link and piano hinges-continuous hinges insert in each fold thus the chamber walls to withstand the increased pressures.

The above described invention of the Mw capacity AC electric generating units can be implemented in a manmade pool, a lake to or in open sea or ocean anywhere around the globe. Therefore it is understood that the total energy required running the hydraulic pumps, sensor, control valves, electric motors, computers and or compressors to assist the elongated open cross-braced jacket truss frames rigid massive formed of tubular arm members is only fractional versus the energy compared to that is generated by the Mw AC electrical generator, this is due to the fact that only two of the said long elongated open cross-braced jacket truss rigid massive actuator arms need to be serviced with energy per side with hydraulic fluid or gas at any given time, the rest of the elongated open cross-braced jacket truss arms are either going up due to buoyancy force to apply positive force to the gearbox shaft or going down to return with aid of gravity weight of the long massive actuator arms without the use of any energy, fifty percent of the long massive actuator arms in the entire electric generating plant is going down due to gravity (weight) and fifty percent is going up due to, buoyancy force thus applying force on one direction due to the overrunning clutch mechanism to the gearbox shaft thereby continuously applying positive rotating force to the gearbox shaft accumulatively. In the present invention the operation of generating Mw AC electric power is controlled and regulated to maintain the desired rpm at the generator end with computers is further accomplished with an aid of a hydraulic system that is controlled by microprocessors.

Referring to FIGS. 11a and 11b one way clutch assembly (overrunning clutch assembly) for larger Mw size generator units. In the present invention on the long gearbox shaft 6 is fixed to a brake shoes assembly and a truck tire rims, a set of truck tires are fixed to the rims thereby as the shaft rotates so does the truck tires. The truck tires road contact surface are encased with thick metal band 9 attached to the long rigid power arm 1. The brake shoes 3 and brake shoes backing plate is fixed to the elongated open cross-braced jacket truss framework interconnected rigid formed of tubular arm member. The brake drum 2 and the tires, along with tire rim 8, is fixed to the gearbox shaft thus upon the cam 7 applied by external air brake boosters or electric ball screw assembly the brakes are applied and the shaft 6 is locked to the drum 2 as the elongated open cross-braced jacket truss framework interconnected rigid formed of tubular arm member 1 turns the gearbox shaft 6 along with the thick metal band 9 is binding the tires 5 with the “Z” type metal strip 4 as it binds to the tire causing the rotation of the tires 5 and the gearbox shaft 6. Due to buoyancy force the positive ascent of the elongated open cross-braced jacket truss framework interconnected rigid formed of tubular arm member the tires 5 is applied by “Z” type metal strip 4 and the brakes 3 are applied at same time causing the gearbox shaft to be turn, this action of binding the tire 5 to the thick metal band 9 and brakes 3 applied to the drum 2 causes the long rigid formed of tubular arm member 1 to overcome an enormous torque applied by the gearbox shaft 6 whereby the generator. With enormous amount of torque required, additional units of the said overrunning clutch assembly can be applied by adding additional units of the said one-way clutch assemblies on both sides of the elongated open cross-braced jacket truss framework interconnected rigid massive formed of tubular arm member as required illustrated in FIG. 8 to turn the gearbox shaft 6 whereby generator to maintain the rpm as required.

Referring to FIG. 12 one way clutch mechanism (overrunning clutch) to turn the large gearbox shaft 4 on the smaller generator unit as well as larger generator units. The elongated open cross truss-braced tubular arm 1 is fixed to the hydraulic calipers 2 and the rotors 3 are fixed to the gearbox shaft 4 thus as a positive reciprocating of the elongated open cross truss-braced tubular 1 arm the hydraulic calipers 2 are applied turning the rotors 3 thereby the gearbox shaft, upon release of the rotors 3 by the hydraulic calipers 2 the elongated open cross truss-braced tubular arm 1 is recovering for the next positive action, this process is repeated on the entire row of the elongated open cross truss-braced tubular arms in the present invention turning the gearbox shaft 4 continuously thereby the generator.

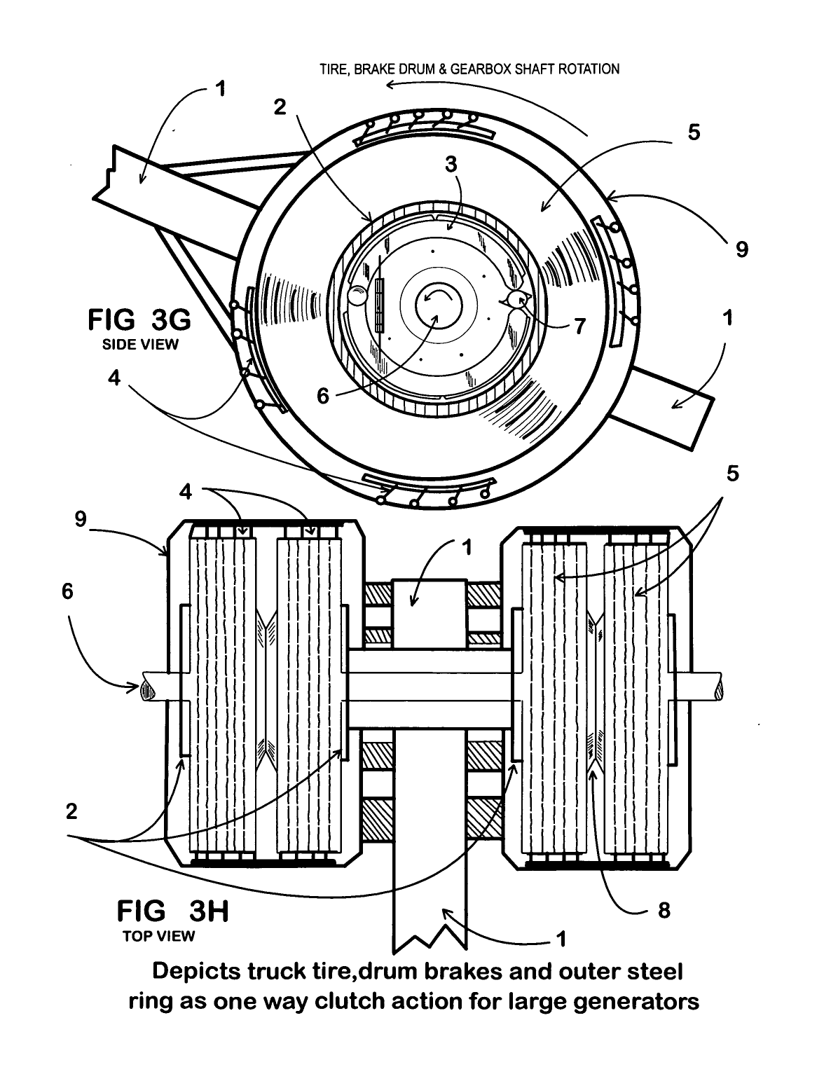

Referring to FIG. 13 one way clutch mechanism (overrunning clutch) to turn the large gearbox shaft, the function of this design is similar as the described in FIG. 12, the major difference is the caliper 1 that is entirely mechanical operated with spring 7 loaded grooved cam jaws 2 that matches the pattern on the rotor 4 and the rotor 4 is partially in the oil bath tank 6 to lubricate the cam jaws 2 and the rotor 4 continuously. The rotor 4 is fixed to the gearbox shaft not shown as the rotor 4 turns on the gearbox shaft, upon a positive stoke the said mechanical calipers that are fixed to the elongated open cross truss-braced tubular arm thus causing the caliper jaws 2 to lock due to matching grove that lock in one direction and releases in the opposite direction as a ratchet action on the rotor 4, the jaws slide 2 on the rotor 4 on recovery phase of the reciprocating action of the said arm. The continuous rotation of the rotor 4 partially in the oil bath 6 lubricates the cams 2 on the said calipers 1 extend the service life of the said ratchet action.

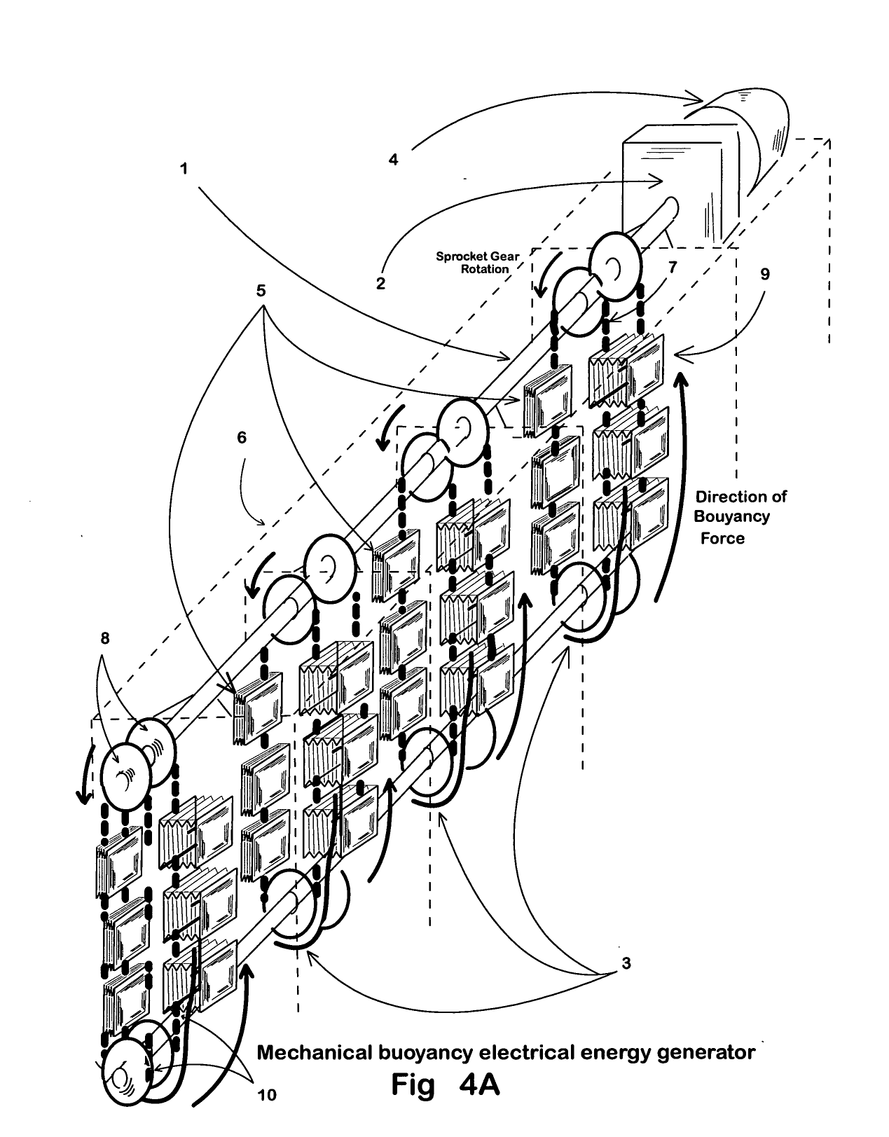

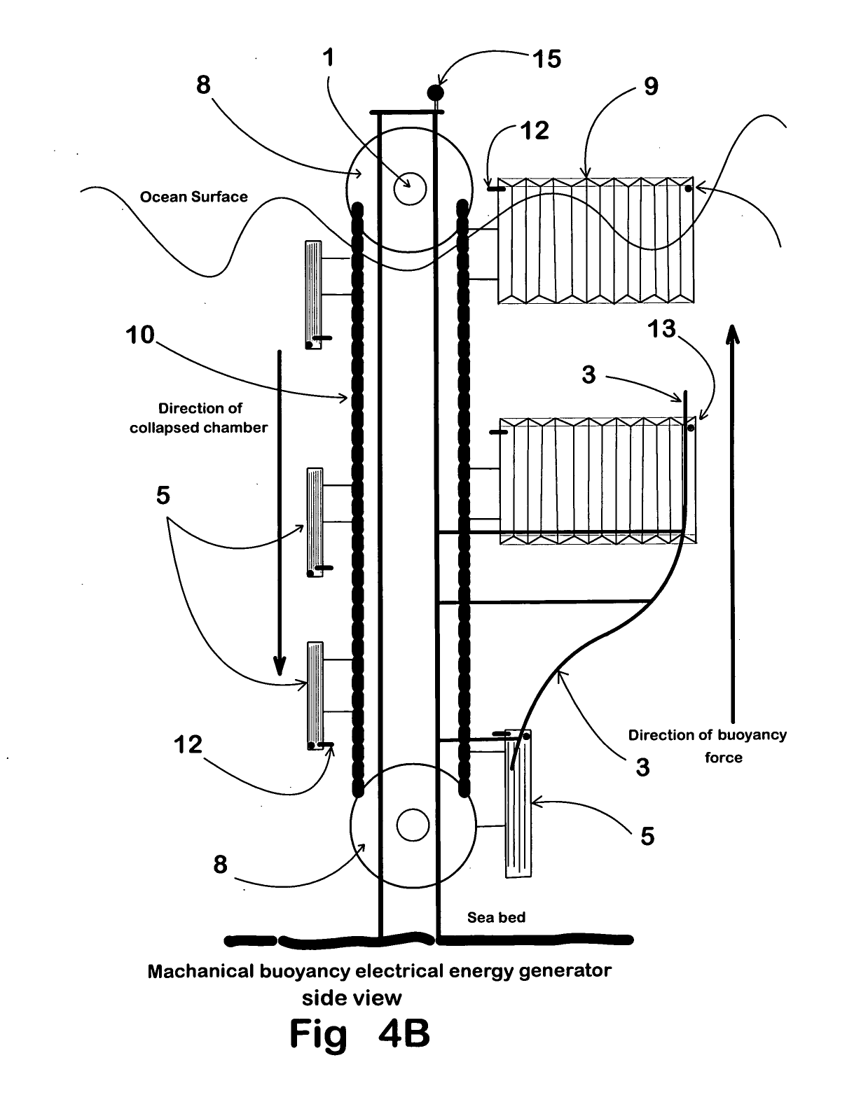

Referring to FIGS. 14, 15 and 16 a mechanical buoyancy electrical generator produces electricity by continuously, repeatedly displaces water in each of the chambers systematically thereby buoyancy force is continuously turning the gearbox main shaft 1. In the present invention the device is constructed in a pool, lake or ocean on a concrete platform 6, the concrete structural deck platform with pillars has a gearbox 2 including a generator 4 end ,shaft 1 with top sprocket gears 8 for each row of buoyancy chambers are individually supported. Selected number of collapsible buoyancy chambers is attached to a single set of sprocket gears 8 on both sides of each every pair of sprocket gears 8 and chain 10. The number of buoyancy chambers attached is evenly divide on both sides of every pair of sprocket gear and chain set as shown in FIG. 14. Both sides of each every pair of sprocket gears 8 and chain 10 has a first side and a second side, the first side is side when the buoyancy chambers are been expended as they first enter the bottom cycle by a rail guide 3 and where the roller guide pins 13 on the rigid top of the buoyancy chamber 9 make contact guiding thereby expending the buoyancy chamber at the same time the locking mechanism 17 locks the expended chamber 9 thus as the upward force of the buoyancy chambers above said expending chamber is moving the sprocket chain turning the gearbox shaft 1. As the cycle continuous the top buoyancy chamber 9 on the first side makes contact with a releasing mechanism 12 on the buoyancy chamber at the top of the platform 15 releasing stud to collapse the spring loaded buoyancy chamber thereby continues on the second side where all of the buoyancy chambers 5 are collapsed whereby the cycle continues to enter the first side again. This repeated process of the buoyancy chambers in each and every pair of sprocket gears and chain, accumulatively all the expended buoyancy chambers have an enormous force to overcome the torque at the gearbox 2. Thus continuously turning the gearbox shaft 1 whereby the gearbox 2, furthermore the rail guide 3 can be extended to cover the entire travel journey of each and every buoyancy chamber in a cycle of travel thereby no need for a locking mechanism 17 to keep the buoyancy chamber expended.

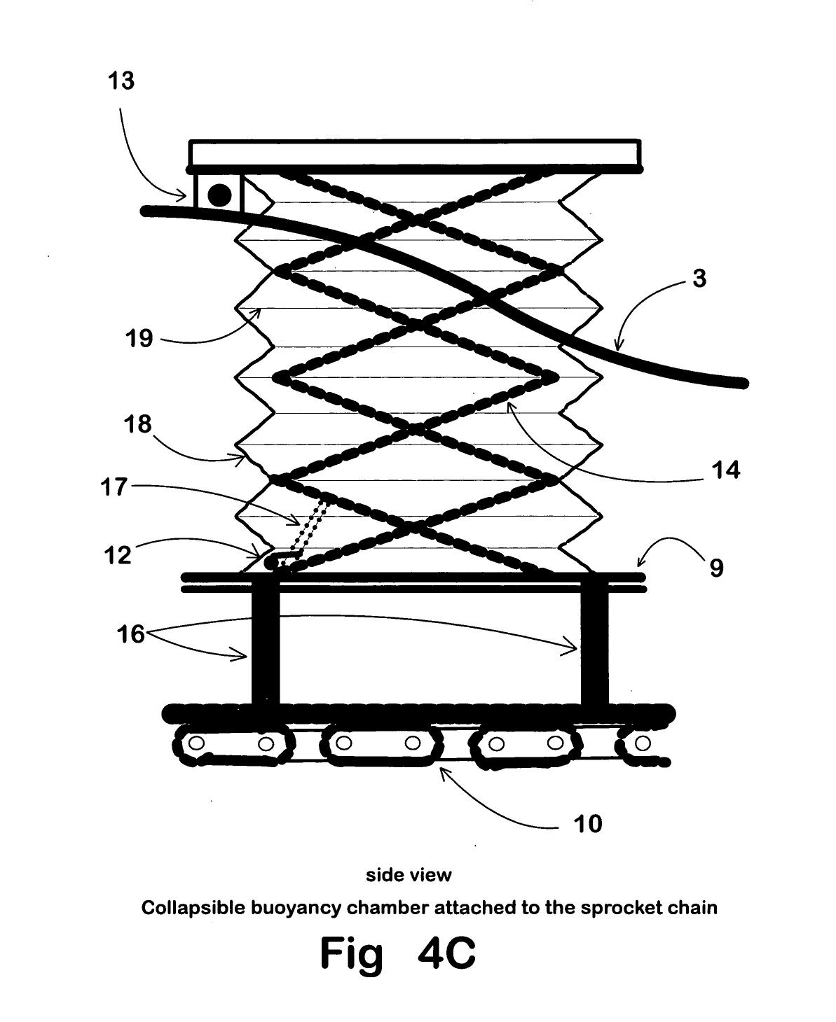

Referring to FIG. 16 a buoyancy chamber for the mechanical buoyancy energy generator of FIG. 14 (#9) where the buoyancy chamber is enclosed with a collapsible folding vinyl or rubber bellows skit 18 is attached to a rigid folding skeleton 19 structure of collapsible bellow chamber frame, the said enclosed buoyancy chamber further contains a scissor jack (lift) 14 mechanism and a locking lever 17 as the chamber expends thus keep the chambers scissor jack 14 expended position until the buoyancy chamber reaches the release stud 15 at the top disengaging the locked lever 12 and collapses the chamber due preloaded spring not shown in the chamber 9. Each of the said buoyancy chamber is mounted on a skid 16 that is fixed at least two set of the sprocket gear 8 and chain 10, to support all the buoyancy chambers in that row. Fifty percent of the buoyancy chamber in the said mechanical electrical energy generating plant is going down due to gravity (weight) and fifty percent is going up due to buoyancy force, the combination of the forces on the gearbox shaft 1 continuously rotationally applying positive rotating forces to the gearbox shaft accumulatively. In the present invention the operation of AC electric power generator is controlled and regulated to maintain the desired rpm at the generator end with the aid of computers.

The present invention can be implemented globally to generate clean electricity on large scale to large industries and homes and supply the grid, furthermore in developing countries and rural villages with no access to electricity where one generator unit of a medium size can power all the surrounding villages and farmers for agriculture needs without need of a grid. Globally start replacing the nuclear and the fossil fuel power plant and add new ones to meet the greater clean energy need worldwide with the present invention. With excessive clean electricity produced globally we can power our automobiles with hydrogen gas as fuel, and produce clean water by using large quantity of hydrogen gas in industries as fuel furthermore oxygen from electrolysis can be given to hospitals and clinics. In the present invention natural buoyancy force and gravity can produce clean and safe electrical power globally for generations to come.

This invention would solve most of the global energy issues as following;

Economic Development;

Greenhouse Gas Emissions Reduction;

Improved Reliability;

Air Quality Improvement;

Environmental Justice;

Policy Leadership/ State or political.

### ILLUSTRATIVE EMBODIMENTS

Although this invention has been described in certain specific embodiments, many additional modifications and variations would be apparent to those skilled in the art. It is, therefore, to be understood that this invention may be practiced otherwise than as specifically described. Moreover, to those skill in the various arts, the invention itself herein will suggest solutions to other tasks and adaptations for other applications. Thus, the embodiments of the invention described herein should be considered in all respects as illustrative and nor restrictive, the scope of the invention to determined by the appended claims and their equivalent rather than foregoing description.

1. The present invention relates to a more precise control of buoyancy force lifting heavy load, for attachment to large structures being lower, lifted, positioned, transported off ocean floor, said buoyancy capsule chamber of a fix size and method comprising of;
a buoyancy capsule chamber of a fix size that can be circular, square, triangular, rectangular or polygonal shape, to the desired length;
the rigid buoyancy chamber capsule comprising symmetrical chamber walls with a skin may be made of stainless steel, aluminum, titanium, fiber reinforced material or other suitable materials with watertight integrity suitable for marine applications under high pressures;
the rigid buoyancy chamber capsules having top end capped with cone or dome shape sealed thus providing a rapid upward movement during ascent of the load in deep water;
a multiple-element of rigid buoyancy capsules attached to the structure to be lifted;
the rigid buoyancy capsules having the bottom end open as to allow water to enter or exit;
the buoyancy chamber apparatus further comprising sealed chamber with a piston connected to a rod piercing through the top capped dome area of the said capsule chamber as a plunger to discharge or take inn water while submerged in water maintaining a seal chamber, thereby buoyancy is adjustably tuned to raise or lower the structure.

2. A collapsible accordion skirt bellow folding buoyancy capsule chamber of a circular, square, triangular, rectangular or polygonal shape comprising of;
a collapsible buoyancy capsule chamber's both end are rigidly enforced across the cross-sectional sealed to maintain a specified volume and overcome external pressure within the chamber as shown in FIG. 2A;
the collapsible buoyancy capsule chamber's structural integrity is made of a rigidly enforced collapsible skeleton frame;
the said collapsible buoyancy capsule chamber's collapsible accordion skirt covering made of fiber reinforced vinyl and or rubber to with stand high pressures;
the said collapsible buoyancy capsule sealed chambers volume is increased or decreased comprising of two methods;
first to have a rod or shaft through top end of said chamber that is fixed to the structure, the one end of the rod in the chamber fixed to the bottom of the chamber thus as the rod is pulled out of the chamber, the floating bottom end of the said chamber causes the buoyancy to decrease and as the rod is push-in the capsule chamber whereby chamber expends thus increases buoyancy;
second method is one end of the collapsible buoyancy capsule sealed chambers is fixed to the structure to be lifted and the opposite end of the said buoyancy capsule is floating to be expended or contracted mechanically from outside chamber hydraulically or cables;

3. A collapsible accordion skirt bellow folding buoyancy capsule chamber of a rectangular or a square shape buoyancy chamber as in FIG. 3F to lift larger heavier structures in the ocean comprising of;
a scissors lift type assisted expending mechanism is enclosed in the said collapsible buoyancy chamber with vinyl skirt and bellows fold follow the movement of the chamber walls to ensure to overcome the external pressures on the said walls are protected thereby maintaining the specified buoyancy;
the individual folds of the collapsible accordion bellow folding buoyancy chamber are protected by a rigid casing as to maintain each fold to the external pressures as in FIG. 3E;
the collapsible accordion skirt bellow folding buoyancy capsule chamber has a rigid skeleton folding structure, the said buoyancy chamber further comprising;
the scissors lift type assisted expending mechanism enclosed in the said buoyancy collapsible bellow chamber is further operated with hydraulic cylinders, electric motor or air motor ball screw, attached to the scissors lift type mechanism thus increasing or decreasing the buoyancy;
a hydraulic pressure supply and return lines and electric and sensor cables that operates the hydraulics or motors in the said collapsible buoyancy chamber is inserted in vented or pressurized gas tubing attached to sealed buoyancy chamber as common that is extended to the surface to control the buoyancy;

4. The present invention relates to a more precise control of buoyancy in pools in generating AC electrical power of a smaller size generators for commercial use with aid of installing a collapsible accordion skirt bellow folding buoyancy capsule chamber of any shape as mentioned above comprising of;
a collapsible bellow folding capsule buoyancy chambers are attached to one end of a long lever arm shown in FIG. 2C, upon the sinusoidal reciprocating motion at midpoint of each of the long lever arms with aid of the buoyancy upward force created by the said collapsible buoyancy chamber in the pool;
a variable weight control mechanism at the other end of the long lever arm applies gravitation downward force;
at midpoint of the long lever arm is a common gearbox shaft is attached that is connected to a gearbox where each long lever arm with of said collapsible buoyancy chamber including variable weight control are as a unit, thus by adding positive sinusoidal reciprocating motion, force individually to overcome the enormous torque created by the gearbox whereby generating electricity;
a active first master hydraulic cylinder located on the long lever arm FIG. 2E (#12)is operated by external electric hydraulic power source, a second hydraulic slave cylinder on the long lever arm is filled with hydraulic fluid as shown in FIG. 2E (#8);
a lower hydraulic cylinder on the long lever arm is the master cylinder, second hydraulic cylinder above, is a slave hydraulic cylinder, where the two hydraulic cylinder shafts are combined operate as one, causing the fluid in the top second hydraulic slave cylinder to operate a third hydraulic cylinder located at the said buoyancy chamber causing a plunger rod or shaft on the buoyancy chamber to operate;
the second upper slave hydraulic cylinder and the third said buoyancy chamber hydraulic cylinder are filled with hydraulic fluid thus operate uniformly as the first active hydraulic cylinder operates;
the second upper slave hydraulic cylinder's diameter located on the long lever arm is larger, shorter than the said buoyancy chamber hydraulic cylinder where the diameter is smaller and the length is longer causing the third said buoyancy chamber hydraulic cylinder to operate the buoyancy chambers piston or diaphragm to travel further, thus increasing the volume of displacing the water;
a sliding of the weights is riding on bearings to reduce fiction;
the sliding of the weight is achieved by a gear rack and pinion where the rack is sliding on bearings on the long lever arm that is pushed by the lower active master first hydraulic cylinder thus causing the involute pinion gear to turn as shown in FIG. 2E;
as the gear rack is pushed by the first master hydraulic cylinder thus turning the involute gear thereby turning a larger sprocket gears causing the sprocket chains that is fixed to the weight is sliding the weights on rollers bearings;
as the gear rack is pushed sliding the weights, the weights have traveled greater distance on the long rigid arm, this is due to smaller involute gear and the much larger sprocket gear, thus would increase the gravitation force on long rigid lever as they weights move further outwards;
additional units of the said long lever arms with all the various mechanisms are connected to the gearbox shaft to meet the required torque to produce AC electrical energy;
as each of the long rigid lever arms are reciprocating are adding rotating force to the gearbox shaft upon the positive rotation of the arm with aid of a one way clutch mechanism (overrunning clutches);
the reciprocating action of the long lever arm at midpoint is taking place, it further understood that upon the positive reciprocating action force to turn the gearbox shaft is achieved by the gravitational weight force on one end of the long lever arm at the same time the buoyancy force on the other end of the same long lever arm to overcome the torque at the gearbox;
upon the negative force or recovery phase the reciprocating action at midpoint on the long lever arm, as the weights are withdrawn towards the center of the long lever arm therefore gravitational force is reduced along with the buoyancy chamber reduced their buoyancy force to zero thus the weight of the two hydraulic cylinders lying down on the long lever arm towards the buoyancy chamber side of the lever arm and the weight of the buoyancy chamber, this additional weight is leaning towards the buoyancy chamber therefore causing buoyancy chambers, vertical column and the buoyancy hydraulic cylinder to go to the bottom of the pool;
the entire function of the buoyancy AC electrical power generator is controlled and monitored by computers.

5. The present invention relates to a more precise control of buoyancy in generating AC electrical power as a larger power plant shown in FIG. 3A, capacity in Mw range in the ocean comprising of;
a circular, square, triangular, rectangular or polygonal shape collapsible accordion skirt bellow folding buoyancy capsule chamber inserted with a scissors lift type assisted expending mechanism;
a concrete structural elongated platform on the ocean surface anchored to the shallow ocean floor;
a pair of gearbox connected shafts is laid out with support structures on the concrete platform almost the entire length of the said platform;
a single or double gearbox shaft can be laid out with support structures on the concrete platform almost the entire length of the said platform and accommodate design changes;
a large Mw size AC electrical generator along with high gear ratio gearbox is mounted at one end or at both end of the said long concrete structure platform;
a elongated open cross-braced jacket truss framework interconnected massive formed of rigid tubular member off-shore reciprocating arms to generate electric power, are attached with to a pair of secured long gearbox shafts further comprising of;
the entire elongated open cross-braced jacket frames formed of tubular members arms are each connected to the long gearbox shaft, perpendicular to the said elongated tubular member as reciprocating long arms having first and second ends;
the said elongated tubular arm member's first end is connected a large one way clutch mechanism which is inserted in the long shaft as to turn a positive rotation on the shaft;
a pair of said long gearbox shaft paralleled located on the concrete platform whereby each shaft has its own sets of said elongated tubular arm member attached back to back at the first end of each elongated tubular arm member to the shaft as in FIG. 3B;
a said second end of the elongated tubular arm member is fixed to a large buoyancy vinyl and or rubber collapsible bellow folding chamber;
the collapsible accordion skirt bellow folding buoyancy capsule chamber inserted with a scissors lift type assisted expending mechanism;
the expandable scissors lift type mechanism operates with hydraulics cylinder or electric motorized ball screw or air motor ball screw mechanism inserted in the said vinyl collapsible bellow folding buoyancy chamber;
the said large vinyl collapsible bellow folding capsule chambers are formed of materials with watertight integrity suitable for marine applications;
additional units of the said elongated tubular arm member with large vinyl collapsible bellow folding capsule chamber along with all the various mechanisms are connected to the gearbox shaft to meet the required torque to produce Mw AC electrical energy;
the entire said units of the elongated tubular arm members reciprocating action along with collapsible accordion skirt bellow folding buoyancy capsule chambers is controlled in a rhythm method as to continually apply a specific amount of force accumulatively required to turn the gearbox shaft as to maintain the set speed thus producing AC electrical power.

6. The present invention relates to a more precise control of buoyancy in generating AC electrical of claim 5, multiple units of jacket elongated tubular member frame off-shore reciprocating arms a positive sinusoidal reciprocating motion by each of the said elongated tubular arm member at the second end applies accumulatively enormous force during the upward buoyancy motion to the said gearbox input shaft thereby the Mw AC generator.

7. The present invention relates to a more precise control of buoyancy in generating AC electrical of claim 5, the size of these collapsible bellow folding chamber can be significantly increased by inserting additional expendable scissors lift type mechanisms side by side in the said collapsible bellow chamber.

8. A multiple units of jacket elongated framework tubular member off-shore reciprocating arms of claim 7 by adding additional collapsible bellow chamber with a scissors lift type assisted expending mechanism on each of the elongated open cross-braced jacket frames formed of tubular members.

9. A one way clutch (overrunning clutch) mechanism to overcome the enormous torque on the gearbox shaft as in FIGS. 2F, 2G and 3G, 3H are all designed to accommodate the present invention to allow the gearbox shaft to rotate continuously upon the positive action on the elongated open cross-braced jacket frames formed of tubular member arms.

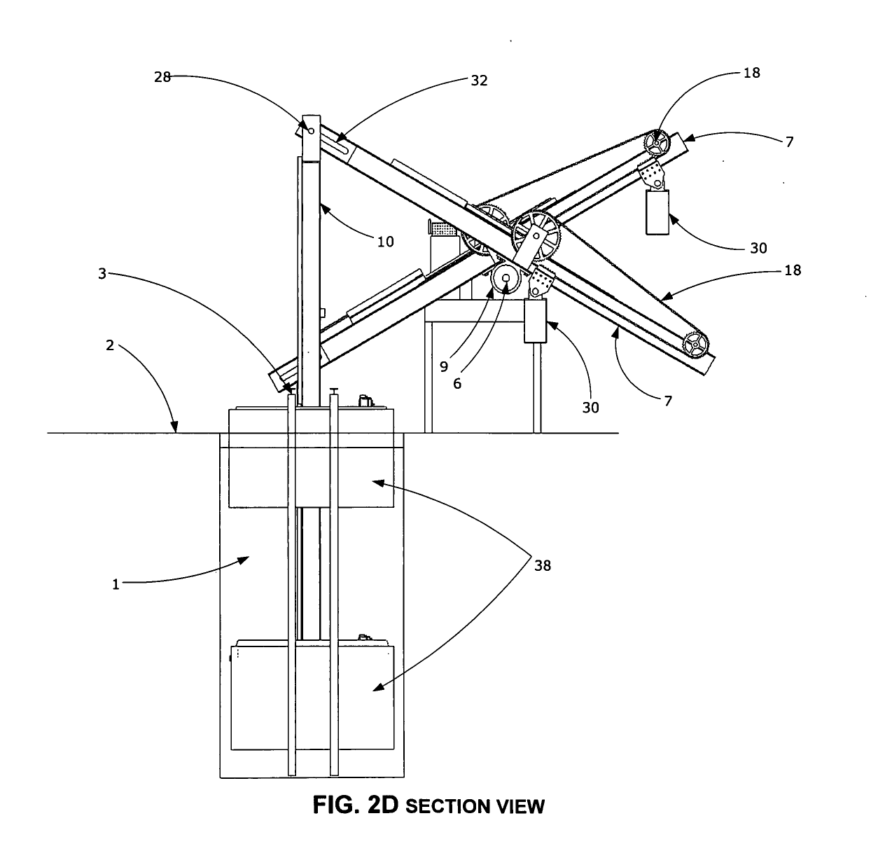

10. A mechanical operated buoyancy electrical energy generating device has a row of vinyl and or rubber collapsible bellow folding buoyancy chamber as in FIG. 4A comprising of;
a platform for a generator and gearbox to accommodate the row of mechanical operated buoyancy electrical energy generating device further comprising of;
a sprocket gear and chain as a conveyer belt type mechanism to turn the gearbox shaft and to transfer buoyancy force from the collapsible bellow folding buoyancy chamber to the gearbox;
the plurality of collapsible bellow folding buoyancy chambers are fixed to the sprocket chains as a conveyer belt mechanism;
the plurality of collapsible bellow folding buoyancy chambers each is enclosed with a scissor jack type of a mechanism to expand or collapse the said buoyancy chambers;
a locking mechanism to lock the extended scissor jacks in of the buoyancy chambers;
the plurality of collapsible bellow folding buoyancy chamber all have a release mechanism to release the expended scissor jack locked to a specific location that is enclosed in each of the said chamber;
at the top of each row of plurality of buoyancy chambers is a release stud that makes contact with each of the said chambers comes up with the release mechanism to collapse the chambers;
the collapsible bellow folding buoyancy chamber has a guide roller bearing pins to glide on the guide on dual rails to expand the said buoyancy chamber;
a guide rails are located at the lower end of the device to expend the collapsible bellow folding buoyancy chamber to its expanded position, the same guide rails could be extended to circle the entire journey of travel of the buoyancy chamber;
the entire function of the said Mw AC electrical power generator is controlled and monitored by computers and microprocessors;
the buoyancy energy generating mechanism in FIG. 4A can be implemented in a pool, ocean or a flowing river as hydro generator.
